(19) United States
(12) Patent Application Publication
(10) Pub. No.: US 2026/0155361 A1
(43) Pub. Date: Jun. 4, 2026

(54) ALL-SOLID STATE BATTERY

(71) Applicants: Nissan Motor Co., Ltd., Kanagawa (JP); RENAULT S.A.S., Boulogne-Billancourt (FR)

(72) Inventor: Yuki Yamamoto, Kanagawa (JP)

(73) Assignees: Nissan Motor Co., Ltd., Kanagawa (JP); RENAULT S.A.S., Boulogne-Billancourt (FR)

(21) Appl. No.: 19/114,738

(22) PCT Filed: Sep. 27, 2022
(86) PCT No.: PCT/IB2022/000569

§ 371 Date: Feb. 13, 2026

(51) Int. Cl. H01M 4/38; H01M 4/02; H01M 4/133; H01M 4/134; H01M 4/587; H01M 4/62; H01M 10/052

(52) U.S. Cl. CPC H01M 4/382; H01M 4/133; H01M 4/134; H01M 4/587; H01M 4/623; H01M 10/052; H01M 2004/021; H01M 2004/027

(57) ABSTRACT

A lithium deposition type all-solid state battery having reliably suppressing short circuits is provided. The all-solid state battery includes a positive electrode, a negative electrode, a solid electrolyte layer that is interposed between the positive electrode and the negative electrode, and an intermediate layer on a surface of the solid electrolyte layer on a side of the negative electrode current collector. The negative electrode includes a negative electrode current collector and a lithium metal anode when the all-solid state battery is in at least partially charged state. The intermediate layer includes a metal particle that can be alloyed with lithium and a carbon particle that can occlude lithium ions.

### TECHNICAL FIELD

The present invention relates to an all-solid state battery.

### BACKGROUND ART

In recent years, research and development on all-solid state batteries using an oxide-based or sulfide-based solid electrolyte as the electrolyte have been actively conducted. The solid electrolyte is a material mainly composed of an ion conductor capable of ion conduction in a solid. For this reason, the all-solid state battery has an advantage in that various problems caused by a combustible organic electrolyte solution do not occur in principle, unlike conventional liquid-base batteries using a nonaqueous electrolyte.

In an all-solid state battery, it is known that when a lithium dendrite deposits on a negative electrode, passes through a solid electrolyte layer and reaches a positive electrode, a problem of short circuits occurs. To suppress short circuits, various techniques have been proposed. For example, in WO 2018/186442, the above problem is solved by setting the porosity of the solid electrolyte layer to 10% or less, and setting the sum of the surface roughness Rz1 of the positive electrode layer and the surface roughness Rz2 of the negative electrode layer to 25 μm or less.

### SUMMARY OF INVENTION

Conventionally, as one type of all-solid state battery, a so-called lithium deposition type battery is known in which lithium metal is deposited on a negative electrode current collector in a charging process. However, when the present inventors applied the technique disclosed in WO 2018/186442 to a lithium deposition type all-solid state battery, they found that short circuits cannot be prevented in some cases.

Thus, an object of the present invention is to provide a means capable of more reliably suppressing short circuits in a lithium deposition type all-solid state battery.

The present inventors have conducted intensive studies in order to solve the above problem. As a result, they found that the above problem can be solved by providing a negative electrode intermediate layer containing a metal that can be alloyed with lithium or a carbon material that can occlude lithium ions between a negative electrode current collector and a solid electrolyte layer, and controlling the surface roughness Rz of a surface of the negative electrode intermediate layer in contact with the solid electrolyte layer to fall within a specific range in a lithium deposition type all-solid state battery having a power generating element. Based on the finding, and the present invention was accomplished.

That is, an embodiment of the present invention relates to an all-solid state battery having a power generating element including: a positive electrode having a positive electrode active material layer containing a positive electrode active material; a negative electrode having a negative electrode current collector and lithium metal deposited on the negative electrode current collector during charging; a solid electrolyte layer intervening the positive electrode and the negative electrode and containing a solid electrolyte; and a negative electrode intermediate layer which exists adjacent to the negative electrode current collector side of the solid electrolyte layer and contains at least one selected from the group consisting of a metallic material that can be alloyed with lithium and a carbon material that can occlude lithium ions. In the all-solid state battery, the surface of the negative electrode intermediate layer adjacent to the solid electrolyte layer has a surface roughness Rz of 2.5 μm or less.

### BRIEF DESCRIPTION OF DRAWINGS

FIG. 1 is a cross-sectional view schematically showing an overall structure of a laminated (internally parallel connection type) all-solid-state lithium secondary battery (laminate type secondary battery) according to an embodiment of the present invention.

### DESCRIPTION OF EMBODIMENTS

An embodiment of the present invention relates to an all-solid state battery having a power generating element including: a positive electrode having a positive electrode active material layer containing a positive electrode active material; a negative electrode having a negative electrode current collector and lithium metal deposited on the negative electrode current collector during charging; a solid electrolyte layer intervening the positive electrode and the negative electrode and containing a solid electrolyte; and a negative electrode intermediate layer which exists adjacent to the negative electrode current collector side of the solid electrolyte layer and contains at least one selected from the group consisting of a metallic material that can be alloyed with lithium and a carbon material that can occlude lithium ions. In the all-solid state battery, the surface of the negative electrode intermediate layer adjacent to the solid electrolyte layer has a surface roughness Rz of 2.5 μm or less. The all-solid state battery according to the embodiment can more reliably suppress short circuits in a lithium deposition type all-solid state battery.

Hereinafter, embodiments of the present invention will be described with reference to the accompanying drawings. In the description of the drawings, the same reference numerals are used to designate the same elements, and redundant description will be omitted. In addition, dimensional ratios in the drawings are exaggerated for convenience, and actual ratios may sometimes differ.

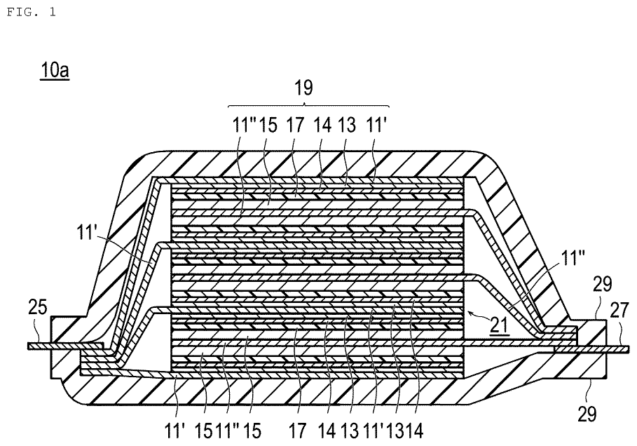

FIG. 1 is a cross-sectional view schematically showing an overall structure of a laminated (internal parallel connection type) all-solid-state lithium secondary battery (hereinafter, it is also simply referred to as a “laminate type secondary battery”) according to an embodiment of the present invention. FIG. 1 shows a cross section of the laminate type secondary battery during charging. A laminate type secondary battery 10a shown in FIG. 1 has a structure in which a substantially rectangular power generating element 21, in which a charge-discharge reaction actually proceeds, is sealed within a laminate film 29 serving as a battery outer casing body. Here, the power generating element 21 has a laminate structure constituted of a negative electrode, a solid electrolyte layer 17, and a positive electrode. The negative electrode has a laminate structure constituted of a negative electrode current collector 11′ and a negative electrode active material layer 13 composed of lithium metal deposited on the surface of the negative electrode current collector 11′. Then, the negative electrode intermediate layer 14 is disposed so as to be adjacent to a surface of the negative electrode active material layer 13 facing the solid electrolyte layer 17. The positive electrode has a structure having a positive electrode active material layer 15 disposed on a surface of a positive electrode current collector 11″. Then, the negative electrode, the solid electrolyte layer, and the positive electrode are laminated in this order such that the negative electrode intermediate layer 14 and the positive electrode active material layer 15 face each other with the solid electrolyte layer 17 interposed therebetween. As a result, the adjacent negative electrode, solid electrolyte layer, and the positive electrode constitute a single battery layer 19. Accordingly, it is said that the laminate type secondary battery 10a shown in FIG. 1 has a structure in which a plurality of single battery layers 19 are laminated and electrically connected in parallel. To the negative electrode current collector 11′ and the positive electrode current collector 11″, a negative electrode current collecting plate 25 and a positive electrode current collecting plate 27, which are electrically connected to the respective electrodes (the negative electrode and the positive electrode), are attached respectively and led out of the laminate film 29 such that they are each sandwiched between end parts of the laminate film 29. A confining pressure is applied to the laminate type secondary battery 10a in the lamination direction of the power generating elements 21 by the pressurizing member (not illustrated). As a result, the volume of the power generating element 21 is kept constant.

Hereinafter, main structural members of the all-solid state battery according to the present embodiment will be described.

### [Current Collector]

The current collector (negative electrode current collector, positive electrode current collector) has a function of mediating transfer of electrons from the electrode active material layer. A material constituting the current collector is not particularly limited. Examples of a constituent material of the current collector that can be employed include a metal such as aluminum, nickel, iron, stainless steel, titanium, or copper, and a resin having conductivity. Also, the thickness of the current collector is not particularly limited, and, for example, 10 to 100 μm.

### [Negative Electrode Active Material Layer]

The all-solid state battery according to the present embodiment is a so-called lithium deposition type in which lithium metal is deposited on a negative electrode current collector in a charging process. The layer composed of lithium metal deposited on the negative electrode current collector in the charging process is the negative electrode active material layer of the all-solid state battery according to the present embodiment. Accordingly, the thickness of the negative electrode active material layer increases with the progress of the charging process, and the thickness of the negative electrode active material layer decreases with the progress of the discharging process. The negative electrode active material layer may not exist during complete discharging, but, in some cases, a negative electrode active material layer made of a certain amount of lithium metal may be disposed during complete discharging. The thickness of the negative electrode active material layer (lithium metal layer) at the time of complete charge is not particularly limited, but is usually 0.1 to 1000 μm.

### [Negative Electrode Intermediate Layer]

The negative electrode intermediate layer is a layer which exists adjacent to a surface of the solid electrolyte layer on the negative electrode current collector side, and contains at least one selected from the group consisting of a metallic material that can be alloyed with lithium and a carbon material that can occlude lithium ions. Since the metallic material and the carbon material have high electron conductivity, the negative electrode intermediate layer has conductivity as a whole. The volume resistivity of the negative electrode intermediate layer is not particularly limited, but is preferably 10² Ω/cm or less, and more preferably 10 Ω/cm or less. In the present specification, as the volume resistivity of the negative electrode intermediate layer, a value measured by an electrode resistance measurement system (product name: RM2610 manufactured by HIOKI E. E. CORPORATION) is employed.

The negative electrode intermediate layer preferably contains at least one selected from the group consisting of metallic materials that can be alloyed with lithium. By containing a metallic material that can be alloyed with lithium in the negative electrode intermediate layer, lithium metal can be more uniformly deposited on the surface of the current collector. Specific examples of the metallic material that can be alloyed with lithium include indium (In), aluminum (Al), silicon (Si), tin (Sn), magnesium (Mg), gold (Au), silver (Ag), zinc (Zn), nickel (Ni), and an alloy containing at least one of these. Among them, the metallic material preferably contains at least one selected from the group consisting of In, Al, Si, Sn, Mg, Au, Ag, Zn and Ni, more preferably contains at least one selected from the group consisting of Ag, Mg, Zn, Ni and Al, further preferably contains at least one selected from the group consisting of Ag, Mg and Zn, and particularly preferably contains Ag.

The negative electrode intermediate layer preferably contains at least one selected from the group consisting of carbon materials that can occlude lithium ions, in place of or in addition to at least one selected from the group consisting of metallic materials that can be alloyed lithium. By containing a carbon material that can occlude lithium ions in the negative electrode intermediate layer, deposition and growth of lithium dendrites can be suppressed. Specific examples of the carbon material that can occlude lithium ions include carbon black (specifically, e.g., acetylene black, Ketjen black (registered trademark), furnace black, channel black, thermal lamp black, or the like), carbon nanotube (CNT), graphite, and hard carbon. In particular, the carbon material preferably contains at least one selected from the group consisting of carbon black, and more preferably contains at least one selected from the group consisting of acetylene black, Ketjen black (registered trademark), furnace black, channel black, and thermal lamp black.

According to a preferred embodiment, the negative electrode intermediate layer contains a mixture of at least one metal particle containing a metallic material that can be alloyed with lithium as mentioned above and at least one carbon particle containing a carbon material that can occlude lithium ions as mentioned above. By forming the negative electrode intermediate layer using the mixture of the metal particles and the carbon particles, short circuits can be further suppressed.

The average particle diameter of the metal particles is preferably 500 nm or less, more preferably 300 nm or less, still more preferably 200 nm or less, and particularly preferably 100 nm or less. The lower limit of the average particle diameter of the metal particles is not particularly limited, but is preferably 20 nm or more. The average particle diameter of the carbon particles is preferably 200 nm or less, more preferably 100 nm or less, and still more preferably 50 nm or less. The lower limit of the average particle diameter of the carbon particles is not particularly limited, but is preferably 10 nm or more. If the average particle diameter of the metal particles and the average particle diameter of the carbon particles fall within the above ranges, it is easy to control the surface roughness Rz (hereinafter, it is also simply referred to as “surface roughness Rz of the negative electrode intermediate layer” or “surface roughness Rz”.) of the surface adjacent to the solid electrolyte layer of the negative electrode intermediate layer described later to fall within a predetermined range. Note that, in the present specification, the average particle diameter of the particles refers to a 50% cumulative diameter (D50) with respect to a particle diameter (maximum distance among distances between any two points of the observed particle on the outline) of the particles observed in several to several tens of fields of view when a cross section of a layer containing the particles is observed by a scanning electron microscope (SEM).

The mass ratio of the metal particles and the carbon particles (metal particles:carbon particles) in the mixture is preferably 10:1 to 1:1, and more preferably 5:1 to 2:1. The volume ratio of the metal particles to the carbon particles (metal particles:carbon particles) is preferably 1:99 to 30:70, and more preferably 5:95 to 25:75. If the blending ratio (mass ratio or volume ratio) of the metal particles and the carbon particles falls within the above range, short circuits can be further suppressed.

When the negative electrode intermediate layer is formed of a mixture of metal particles and carbon particles, it is preferable that the negative electrode intermediate layer further contains a binder. The type of binder is not particularly limited, and those known in the technical field to which the invention pertains can be appropriately employed. Examples of the binder include polyvinylidene fluoride (PVDF), a compound obtained by substituting a hydrogen atom of PVDF with another halogen element, polytetrafluoroethylene (PTFE), styrene-butadiene rubber (SBR), and carboxymethyl cellulose (CMC). Among them, from the viewpoint of controlling the surface roughness Rz and the thickness d of the negative electrode intermediate layer (described later) to fall within predetermined ranges, the binder preferably contains polyvinylidene fluoride (PVDF), and more preferably is polyvinylidene fluoride (PVDF).

When the negative electrode intermediate layer contains a binder, the content of the binder is preferably more than 10 parts by mass and more preferably 12 parts by mass or more to 100 parts by mass of a mixture of metal particles and carbon particles. If the content of the binder falls within the above range, it is easy to control the surface roughness Rz (hereinafter, it is also simply referred to as “surface roughness Rz of the negative electrode intermediate layer” or “surface roughness Rz”) of the surface adjacent to the solid electrolyte layer in the negative electrode intermediate layer (described later) falls within a predetermined range. The upper limit of the content of the binder is not particularly limited, but is preferably 20 parts by mass or less from the viewpoint of suppressing an increase in resistance.

The ratio of the total mass of the metallic material, the carbon material, and the binder to the total mass of the negative electrode intermediate layer is preferably 90 mass % or more, more preferably 95 mass % or more, still more preferably 98 mass % or more, particularly preferably 99 mass or more, and most preferably 100 mass %.

In the all-solid state battery according to the present embodiment, a surface of the negative electrode intermediate layer adjacent to the solid electrolyte layer has a surface roughness Rz of 2.5 μm or less. If the surface roughness Rz exceeds 2.5 μm, deposition and growth of lithium dendrite cannot be sufficiently suppressed, and short circuits may occur. If the surface roughness Rz exceeds 2.5 μm, the solid electrolyte contained in the solid electrolyte layer may enter the vicinity of the negative electrode active material layer (metal lithium deposited on the negative electrode current collector), with the result that the solid electrolyte may deteriorate due to reductive decomposition by the deposited metal lithium. Furthermore, if the surface roughness Rz exceeds 2.5 μm, the strength of the negative electrode intermediate layer may decrease to cause cracking. From the same viewpoint, the surface roughness Rz is more preferably 2.0 μm or less, and still more preferably 1.0 μm or less. On the other hand, the surface roughness Rz is preferably 0.5 μm or more from the viewpoint of ensuring a contact area with the solid electrolyte layer and preventing delamination between the negative electrode intermediate layer and the solid electrolyte layer. That is, according to a preferred embodiment of the present invention, the surface roughness Rz is 0.5 μm or more and 2.0 μm or less. According to a more preferred embodiment of the present invention, the surface roughness Rz is 0.5 μm or more and 1.0 μm or less. In the present specification, as the surface roughness Rz (maximum height roughness), a value measured by a method described in Examples (described later) is employed.

A method of controlling the surface roughness Rz of the negative electrode intermediate layer to fall within a predetermined range is not particularly limited, but a method employing a two-stage pressurization treatment, that is, a pressurization treatment for applying a predetermined pressure to the solid electrolyte layer, and a pressurization treatment for applying a predetermined pressure to a laminate of the solid electrolyte layer and the negative electrode intermediate layer, can be employed, in producing all-solid state battery. More specifically, a solid electrolyte slurry containing a solid electrolyte is applied to the surface of a support (for example, metal foil), and the coating film is dried to obtain a solid electrolyte layer formed on the surface of the support. Thereafter, the solid electrolyte layer formed on the surface of the support is pressed at a predetermined pressure (first press step). As a result, the solid electrolyte particles of the solid electrolyte layer present on the surface adjacent to the support are orderly arranged to reduce the unevenness. After the support used for forming the solid electrolyte layer is removed, pressing may be performed using, e.g., another metal foil. Alternatively, before the first press step, the solid electrolyte layer and the positive electrode active material layer are laminated such that the exposed surface of the separately prepared positive electrode active material layer is disposed on the exposed surface of the solid electrolyte layer and, in this state, the first press step may be performed. In contrast, a negative electrode active material slurry containing a material (metal particles and/or carbon particles and an optionally added binder) contained in the negative electrode intermediate layer is applied to the surface of the negative electrode current collector (for example, stainless steel foil), and the coating film is dried to obtain a negative electrode intermediate layer formed on the surface of the negative electrode current collector. Then, the support (metal foil) used in the first press step is removed to expose the solid electrolyte layer, and the solid electrolyte layer and the negative electrode intermediate layer are laminated in such a manner that the exposed surfaces of them face with each other, and pressed at a predetermined pressure (second press step). As a result, the surface roughness of the surface of the negative electrode intermediate layer adjacent to the solid electrolyte layer is adjusted. Cold isostatic pressing (CIP) is suitable for pressing in the first press step and the second press step, but the pressing method is not limited thereto.

In the above production method, it is preferable not to apply pressurization treatment only to the negative electrode intermediate layer before the second press step. This is because, if pressurization treatment is applied only to the negative electrode intermediate layer, even if, in the subsequent second press step, pressurization treatment is applied to a laminate of the negative electrode intermediate layer and the solid electrolyte layer, the negative electrode intermediate layer and the solid electrolyte layer are less likely to adhere to each other, and these layers may delaminate at their interface.

The pressing pressure to be applied in the first press step and the pressing pressure to be applied in the second press step vary depending on the materials contained in the solid electrolyte layer and the negative electrode intermediate layer, and can be appropriately set by those skilled in the art. As an example, the pressing pressure to be applied in the first press step is preferably 300 MPa or more and 1000 MPa or less, more preferably 300 MPa or more and 800 MPa or less, and still more preferably 500 MPa or more and 700 MPa or less. The pressing pressure to be applied in the second press step is preferably 100 MPa or more and 700 MPa or less, more preferably 300 MPa or more and 500 MPa or less, and still more preferably 400 MPa or more and 500 MPa or less. In particular, if the pressing pressure to be applied in the first press step is too small (about 100 MPa), unevenness due to the solid electrolyte particles increases, and the surface roughness Rz of the negative electrode intermediate layer may exceed 2.5 μm.

The ratio of the pressing pressure to be applied in the first press step to the pressing pressure to be applied in the second press step (pressing pressure applied in the first press step/pressing pressure applied in the second press step) is preferably 0.5 or more and 10 or less, more preferably 1 or more and 5 or less, still more preferably 1 or more and 2 or less, and particularly preferably 1.25 or more and 1.75 or less. If the ratio falls within the above range, the surface roughness Rz of the negative electrode intermediate layer can be controlled to 2.5 μm or less, and cracking of the negative electrode intermediate layer can be prevented.

The thickness d of the negative electrode intermediate layer is preferably small from the viewpoint of improving the energy density of the all-solid state battery. Specifically, the thickness d of the negative electrode intermediate layer is preferably 10 μm or less, more preferably 5 μm or less, and still more preferably 4.5 μm or less. The lower limit of the thickness d of the negative electrode intermediate layer is not particularly limited, but is preferably 3 μm or more, and more preferably 3.5 μm or more from the viewpoint of ensuring the strength of the negative electrode intermediate layer. In the present specification, as the thickness d of the negative electrode intermediate layer, a value measured by a method described in Examples (described later) is employed.

The ratio (percentage: (Rz/d)×100(%)) of the surface roughness Rz to the thickness d of the negative electrode intermediate layer is preferably 1% or more and 65% or less, more preferably 5% or more and 50% or less, still more preferably 10% or more and 30% or less, and particularly preferably 12.5% or more and 25.08 or less. If the ratio falls within the above range, short circuits can be further suppressed.

### [Solid Electrolyte Layer]

The solid electrolyte layer is interposed between the negative electrode and the positive electrode, and contains a solid electrolyte (usually as a main component). The solid electrolyte to be contained in the solid electrolyte layer is not particularly limited, and those known in the technical field to which the invention pertains can be appropriately employed. Examples include sulfide solid electrolytes such as LPS (Li₂S—P₂S₅)), Li₆PS₅X (wherein X is Cl, Br or I), Li₇P₃S₁₁, Li_{3.2}P_{0.96}S, and Li₃PS₄. These sulfide solid electrolytes are preferably used because of having excellent lithium-ion conductivity and because of capable of following the volumetric changes of the electrode active material resulting from charging and discharging due to the volume modulus of the electrolytes being low.

The ionic conductivity (for example, Li ion conductivity) of the sulfide solid electrolyte at normal temperature (25° C.) is, for example, preferably 1×10⁻⁵ S/cm or more, and more preferably 1×10⁻⁴ S/cm or more. The value of the ionic conductivity of the solid electrolyte can be measured by an AC impedance method.

Examples of the shape of the solid electrolyte include particle shapes such as a perfect spherical shape and an elliptical spherical shape, and thin film shapes. If the solid electrolyte has a particle shape, the average particle diameter (D50) is not particularly limited, but is preferably 0.01 μm or more and 40 μm or less, more preferably 0.1 μm or more and 20 μm or less, and still more preferably 0.5 μm or more and 10 μm or less.

The content of the solid electrolyte in the solid electrolyte layer is preferably 50 to 100 mass %, and more preferably 90 to 100 mass %.

The solid electrolyte layer may further contain a binder in addition to the solid electrolyte.

The thickness of the solid electrolyte layer varies depending on the constitution of a desired all-solid state battery, but is usually 0.1 to 1000 μm and preferably 10 to 40 μm.

### [Positive Electrode Active Material Layer]

The positive electrode active material layer essentially contains a positive electrode active material, and may contain a binder or a conductive aid as necessary.

The type of positive electrode active material contained in the positive electrode active material layer is not particularly limited. Examples thereof include layered rock salt type active materials such as LiCoO₂, LiMnO₂, LiNiO₂, LiVO₂, Li(Ni—Mn—Co) Oz, spinel type active materials such as LiMn₂O₄ and LiNi_{0.5}Mn_{1.5}O₄, olivine type active materials such as LiFePO₄ and LiMnPO₄, and Si-containing active materials such as Li₂FeSiO₄ and Li₂MnsiO₄. Examples of the oxide active material other than those described above include Li₄Ti₅O₁₂. Among them, Li(Ni—Mn—Co)O₂ and a material obtained by partly substituting these transition metals with other elements (hereinafter, also simply referred to as “NMC composite oxide”) are preferably used as the positive electrode active material.

It is also one of preferred embodiments that a sulfur-based positive electrode active material is used. Examples of the sulfur-based positive electrode active material include particles or thin films of an organic sulfur compound or an inorganic sulfur compound. Any substance may be used as long as it can release lithium ions during charging and occlude lithium ions during discharging by use of the oxidation-reduction reaction of sulfur.

The content of the positive electrode active material in the positive electrode active material layer is preferably 50 to 100 mass %, more preferably 55 to 95 mass %, and still more preferably 60 to 90 mass.

The thickness of the positive electrode active material layer varies depending on the constitution of the desired all-solid state battery, but is usually 0.1 to 1000 μm and preferably 10 to 40 μm.

In the above, an embodiment of the all-solid state battery of the present invention has been described, but the present invention is not limited only to the constitution as described in the embodiment mentioned above, and can be appropriately modified based on the description of the claims.

Note that the following embodiments are also included in the scope of the present invention: the all-solid state battery according to claim 1 having the features of claim 2; the all-solid state battery according to claim 1, having the features of claim 3; the all-solid state battery according to any one of claims 1 to 3, having the feature of claim 4; the all-solid state battery according to any one of claims 1 to 4, having the features of claim 5; the all-solid state battery according to any one of claims 1 to 5, having the features of claim 6; the all-solid state battery according to claim 6, having the features of claim 7; the all-solid state battery according to claim 6 or 7, having the features of claim 8; the all-solid state battery according to any one of claims 6 to 8 having the feature of claim 9; and the all-solid state battery according to claim 9, having the features of claim 10.

### EXAMPLES

Hereinafter, the present invention will be described in more detail with reference to Examples. However, the technical scope of the present invention is not limited only to the following examples. In the following description, the instruments, devices, and others used in a glove box were sufficiently dried in advance.

### <Preparation Examples of Evaluation Cell>

### Example 1

### (Preparation of Positive Electrode)

In a glove box under an argon atmosphere at a dew point of −68° C. or lower, an NMC composite oxide (LiNi_{0.8}Mn_{0.1}Co_{0.1}O₂) as a positive electrode active material, a carbon fiber as a conductive aid, and an argyrodite-type sulfide solid electrolyte (Li₆PS₅Cl) as a solid electrolyte were weighed so as to have a mass ratio of 50:30:20. These were mixed using an agate mortar, and then further stirred and mixed by a planetary ball mill. Two parts by mass of polytetrafluoroethylene (PTFE) as a binder was added to the obtained mixed powder (100 parts by mass) and mixed. The obtained mixture was laminated on an aluminum foil as a positive electrode current collector and pressed to obtain a positive electrode having a positive electrode active material layer (thickness: 50 μm) on the surface of the positive electrode current collector.

### (Preparation of Solid Electrolyte Layer)

In a glove box under an argon atmosphere at a dew point of −68° C. or lower, 2 parts by mass of SBR as a binder was added to 100 parts by mass of argyrodite-type sulfide solid electrolyte (Li₆PS₅Cl, average particle diameter (D50): 0.8 μm) as a solid electrolyte, and mesitylene as a solvent was added and mixed to prepare solid electrolyte slurry. The solid electrolyte slurry was applied onto the surface of a stainless steel foil as a support and dried to obtain a solid electrolyte layer (thickness: 30 μm).

### (Preparation of Negative Electrode Intermediate Layer)

Silver nanoparticles (average particle diameter (D50): 60 nm) and carbon black (average particle diameter (D50): 12 nm) were weighed so as to have a mass ratio of Ag:C=1:3, and mixed. To 88 parts by mass of the obtained mixture, 12 parts by mass of polyvinylidene fluoride (PVDF) as a binder was added, and mesitylene as a solvent was added and mixed to prepare negative electrode intermediate layer slurry. The negative electrode intermediate layer slurry was applied onto the surface of a stainless steel foil as a negative electrode current collector and dried to obtain a negative electrode intermediate layer (thickness before pressing treatment: 10 μm).

### (Preparation of Evaluation Cell)

A positive electrode active material layer formed on a surface of an aluminum foil (positive electrode current collector) and a solid electrolyte layer formed on a surface of a stainless steel foil were laminated in such a manner that an exposed surface of the positive electrode active material layer and an exposed surface of the solid electrolyte layer faced each other, and pressed at 700 MPa for one minute by cold isostatic pressing (CIP) (first press step). As a result, the solid electrolyte layer was transferred to the exposed surface of the positive electrode active material layer, and the solid electrolyte particles of the solid electrolyte layer present on the surface adjacent to the stainless steel foil were orderly arranged to reduce unevenness. After the stainless steel foil adjacent to the solid electrolyte layer was removed, the solid electrolyte layer and the negative electrode intermediate layer formed on the surface of the stainless steel foil (negative electrode current collector) were laminated in such a manner that the exposed surface of the solid electrolyte layer and the exposed surface of the negative electrode intermediate layer faced each other, and pressed at 100 MPa for one minute by cold isostatic pressing (CIP) (second press step). As a result, the negative electrode intermediate layer was transferred to the exposed surface of the solid electrolyte layer, and the surface roughness of the surface of the negative electrode intermediate layer adjacent to the solid electrolyte layer was adjusted. Finally, an aluminum positive electrode tab and a nickel negative electrode tab were joined to an aluminum foil (positive electrode current collector) and a stainless steel foil (negative electrode current collector) respectively by an ultrasonic welding machine, and the obtained laminate was placed within an aluminum laminate film and vacuum-sealed to obtain an evaluation cell which is a lithium deposition type all-solid state battery of this Example.

### Example 2

An evaluation cell of this example was produced in the same manner as in Example 1 except that the pressure applied in the second press step of the above (Preparation of Evaluation Cell) was changed to 400 MPa.

### Example 3

An evaluation cell of this example was produced in the same manner as in Example 1 except that the pressure applied in the second press step of the above (Preparation of Evaluation Cell) was changed to 500 MPa.

### Example 4

An evaluation cell of this example was produced in the same manner as in Example 3 except that the pressing pressure to be applied in the first press step of the above (Preparation of Evaluation Cell) was changed to 600 MPa.

### Example 5

An evaluation cell of this example was produced in the same manner as in Example 3 except that the pressing pressure to be applied in the first press step of the above (Preparation of Evaluation Cell) was changed to 500 MPa.

### Example 6

An evaluation cell of this example was produced in the same manner as in Example 3 except that the pressing pressure to be applied in the first press step of the above (Preparation of Evaluation Cell) was changed to 300 MPa.

### Comparative Example 1

An evaluation cell of this Comparative Example was produced in the same manner as in Example 3 except that the pressing pressure to be applied in the first press step of the above (Preparation of Evaluation Cell) was changed to 100 MPa.

<Measurement of Surface Roughness Rz and Thickness d>

The power generating element was taken out from the evaluation cell (before the initial charge) prepared above, and a cross section perpendicular to the plane direction (parallel to the lamination direction) was exposed by ion milling. The cross section was observed by a scanning electron microscope (SEM), and an image (visual field: 200 μm×200 μm) of the interface between the negative electrode intermediate layer and the solid electrolyte layer was taken. With respect to the obtained image, the surface roughness Rz of the negative electrode intermediate layer at the interface between the negative electrode intermediate layer and the solid electrolyte layer (the surface roughness Rz of the surface of the negative electrode intermediate layer adjacent to the solid electrolyte layer) was measured by image analysis software (WinROOF2021 manufactured by MITANI CORPORATION). Also, the cross section was observed by SEM, the thicknesses of several to several tens of different sites in the negative electrode intermediate layer were measured, and the arithmetic average value thereof was defined as the thickness d of the negative electrode intermediate layer. Then, the ratio (percentage: (Rz/d)×100(%)) of the surface roughness Rz to the thickness d of the negative electrode intermediate layer was calculated. The obtained values are shown in Table 1 below.

The surface roughness Rz of the evaluation cell after the charge-discharge test (described later) was also measured by the same method as above. As a result, it was confirmed that the surface roughness Rz was the same value as the surface roughness Rz of the evaluation cell before the initial charge.

### <Charge-Discharge Test>

A positive electrode lead and a negative electrode lead were connected respectively to the positive electrode current collector and the negative electrode current collector of the evaluation cell (before initial charge) prepared above, and charge and discharge were performed in accordance with the following charge-discharge test conditions. At this time, the following charge-discharge test was performed while applying a confining pressure of 3 MPa in the lamination direction of the evaluation cells by the pressurizing member.

### (Charge-Discharge Test Conditions)

Evaluation temperature: 333 K (60° C.)
Voltage range: 2.5 to 4.3 V
Charging process: CCCV (0.02 C cut-off)
Charge rate: 3.5 C
Discharging process: CC
Discharge rate: 0.1 C

Each after charging and discharging processes, take a 30 minute's break.

The evaluation cell was charged up to 4.3 V at 3.5 C (0.02 C cut-off) in a constant current/constant voltage (CCCV) mode in a charging process (lithium metal is deposited on the negative electrode current collector) in a thermostatic bath set at the above evaluation temperature by a charge-discharge tester. Thereafter, in the discharging process (lithium metal on the negative electrode current collector is dissolved), the battery was discharged to 2.5 V at 0.1 C in a constant current (CC) mode. Here, 1 C refers to a current value at which if a battery is charged for one hour, the battery is fully charged (100% charged). Ten evaluation cells were prepared and subjected to the charge-discharge process as mentioned above. At this time, the number of cells in which no short circuit occurred was counted. The presence or absence of a short circuit was determined by confirming whether or not the ratio of the discharge capacity to the charge capacity was less than 99%. If the ratio of a battery was less than 99%, it was determined that the battery has a short circuit. On the other hand, if the ratio of a battery was 998 or more, it was determined that the battery has no short circuit. Among the 10 evaluation cells, the case where the number of cells having no short circuit was 9 or more was evaluated as “⊙” (excellent); the case where the number was 7 or more was evaluated as “◯” (good); the case where the number was 5 or more was evaluated as “Δ” (satisfactory); and the case where the number was 4 or less was evaluated as “x” (poor). The results are shown in Table 1 below.

TABLE 1

| | | | | Pressing | Pressing | |
|---|---|---|---|---|---|---|
| | | | | pressure | pressure | |
| | | | | applied in | applied in | |
| | Negative electrode | | | first | second | |
| | intermediate layer | | | pressing | pressing | Charge- |
| | d | Rz | (Rz/d) × | step | step | discharge |
| | (μm) | (μm) | 100 (%) | (Mpa) | (Mpa) | test |
| Example 1 | 4 | 0.05 | 1.25 | 700 | 100 | Δ |
| Example 2 | 4 | 0.5 | 12.5 | 700 | 400 | ⊙ |
| Example 3 | 4 | 1 | 25.0 | 700 | 500 | ⊙ |
| Example 4 | 4 | 1.5 | 37.5 | 600 | 500 | ◯ |
| Example 5 | 4 | 2 | 50.0 | 500 | 500 | ◯ |
| Example 6 | 4 | 2.5 | 62.5 | 300 | 500 | Δ |
| Comparative | 4 | 3 | 75.0 | 100 | 500 | X |
| Example 1 | | | | | | |

From the results in Table 1, it is found that short circuits can be more reliably suppressed in a lithium deposition type all-solid state battery according to the present invention.

### REFERENCE SIGNS LIST

10a Laminate type secondary battery
11′ Negative electrode current collector
11″ Positive electrode current collector
13 Negative electrode active material layer
14 Negative electrode intermediate layer
15 Positive electrode active material layer
17 Solid electrolyte layer
19 Single battery layer
21 Power generating element
25 Negative electrode current collecting plate
27 Positive electrode current collecting plate
29 Laminate film

1. An all-solid state battery comprising:
a positive electrode;
a negative electrode comprising a negative electrode current collector and a lithium metal anode when the all-solid state battery is in at least partially charged state;
a solid electrolyte layer that is interposed between the positive electrode and the negative electrode; and
an intermediate layer on a surface of the solid electrolyte layer on a side of the negative electrode current collector comprising a metal particle that can be alloyed with lithium and a carbon particle that can occlude lithium ions, wherein
a surface roughness Rz of the intermediate layer on a side of the solid electrolyte layer is 2.5 μm or less.

2. The all-solid state battery according to claim 1, wherein the surface roughness Rz is 0.5 μm or more and 2.0 μm or less.

3. The all-solid state battery according to claim 1, wherein the surface roughness Rz is 0.5 μm or more and 1.0 μm or less.

4. The all-solid state battery according to claim 1, wherein a thickness d of the negative electrode-intermediate layer is 10 μm or less.

5. The all-solid state battery according to claim 1, wherein a ratio of the surface roughness Rz to a thickness d of the intermediate layer is 1% or more and 65% or less.

6. (canceled)

7. The all-solid state battery according to claim 1, wherein the metal particle comprises a material selected from the group consisting of indium, aluminum, silicon, tin, magnesium, gold, silver, zinc, nickel, and combinations thereof, and the carbon particle is selected from the group consisting of carbon black, carbon nanotubes, graphite, hard carbon, and combinations thereof.

8. The all-solid state battery according to claim 1, wherein a mass ratio of the metal particle to the carbon particle in the intermediate layer is 10:1 to 1:1.

9. The all-solid state battery according to claim 1, wherein the intermediate layer further comprises a binder in an amount exceeding 10 parts by mass with respect to 100 parts by mass of a mixture of the metal particle and the carbon particle.

10. The all-solid state battery according to claim 9, wherein the binder comprises polyvinylidene fluoride.

11. The all-solid state battery according to claim 2, wherein a thickness d of the intermediate layer is 10 μm or less.

12. The all-solid state battery according to claim 2, wherein a ratio of the surface roughness Rz to a thickness d of the intermediate layer is 1% or more and 65% or less.
